(19) United States
(12) Patent Application Publication
(10) Pub. No.: US 2022/0027369 A1
(43) Pub. Date: Jan. 27, 2022

(54) QUERY-BASED ROUTING OF DATABASE REQUESTS

(71) Applicant: Instant Labs, Inc., Santa Clara, CA (US)

(72) Inventors: Ajit Shantilal Shah, Portola Valley, CA (US); Hal Spitz, Oakland, CA (US); Eric Kiebler, Half Moon Bay, CA (US); Rene Stein, Palo Alto, CA (US); John McLaughlin, Roseland, NJ (US); Brigand Balleau, Albany, CA (US)

(21) Appl. No.: 17/365,963

(22) Filed: Jul. 1, 2021

Related U.S. Application Data
(60) Provisional application No. 63/048,543, filed on Jul. 6, 2020.

(51) Int. Cl. G06F 16/2453; G06F 16/2457; G06F 11/34

(52) U.S. Cl. CPC G06F 16/24545; G06F 16/24575; G06F 11/3409; G06F 16/24539; G06F 16/24537

(57) ABSTRACT

Query-based routing of database requests is disclosed. In various embodiments, a database request is received via a communication interface. The request is parsed to extract one or more data elements associated with the request. Based at least in part on the one or more data elements extracted from the request, a selected one of a plurality of partial data set instances is selected, each partial data set instance including a corresponding subset of data from a set of origin data. The request is routed to the selected partial data set instance.

### CROSS REFERENCE TO OTHER APPLICATIONS

This application claims priority to U.S. Provisional Patent Application No. 63/048,543 entitled QUERY-BASED ROUTING OF DATABASE REQUESTS filed Jul. 6, 2020 which is incorporated herein by reference for all purposes.

### BACKGROUND OF THE INVENTION

Enterprises, government entities, and other owners of large quantities of data use large database systems to store, update, analyze, and provide access to data. A common type of database in current use is the relational database management system or RDBMS type database system. A relational database management system is based on the relational model of data.

Modern database systems can handle large volumes of data and provide powerful tools to access and manipulate data. However, the power of modern database systems and the wide range of functionality provided can result in latency and high resource consumption. Some tasks require the full capability of a modern RDBMS, while other tasks are more straightforward but still require substantial time and resources to perform when using an RDBMS or other traditional, full function enterprise class database.

### BRIEF DESCRIPTION OF THE DRAWINGS

Various embodiments of the invention are disclosed in the following detailed description and the accompanying drawings.

FIG. 1 is a block diagram illustrating an embodiment of a system for optimized data access.

FIG. 2A is a block diagram illustrating an embodiment of a distributed access an environment comprising two or more systems.

FIG. 2B is a block diagram illustrating an embodiment of a distributed database access system.

FIG. 3A is a block diagram illustrating an embodiment of a distributed database system configured to provide optimized data access, including by processing a query at a data access node selected as being optimal to process that query.

FIG. 3B is a block diagram illustrating an embodiment of a distributed database system configured to provide optimized data access, including a query router configured to select a data access node as being optimal to process a given query.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Techniques are disclosed to provide optimized access to data. In various embodiments, a distributed data model and architecture is implemented and used to provide optimized access to data. One or more subsets of data comprising a database, e.g., one or more subsets each associated with a set of queries and/or other access requirements, such as those associated with a particular application, user or user group, geographic location, etc. are stored each in one or more distributed access nodes. In some embodiments, data in a subset may be transformed to facilitate optimized access. One or more new or modified indexes may be created and stored, and the access node configured to use the new or modified index(es) to process queries.

In various embodiments, a query, such as a query associated with an application and expressed in traditional SQL, may be transformed into a transformed query optimized to best take advantages of data transformation, new/modified indexes, etc., associated with the target data as stored at a data access node as disclosed herein.

In various embodiments, a query may be received and parsed, and data associated with the query may be used to cause the query to be routed for service by an optimal data access node. For example, in some embodiments, a query may be sent for processing—via a mechanism as disclosed herein—by a data access node that stores an instance of data that has been selected (into a subset) and transformed in a manner that makes the selected data access node an optimal candidate to service the query. In some embodiments, load balancing, quality of service, and/or other policies may be taken into consideration in selecting a data access node to service a request. In some embodiments, a data access node may be selected based on dynamically determined state information and/or by applying one or more rules, policies, heuristics, algorithms and/or other selection techniques, tools, and/or criteria.

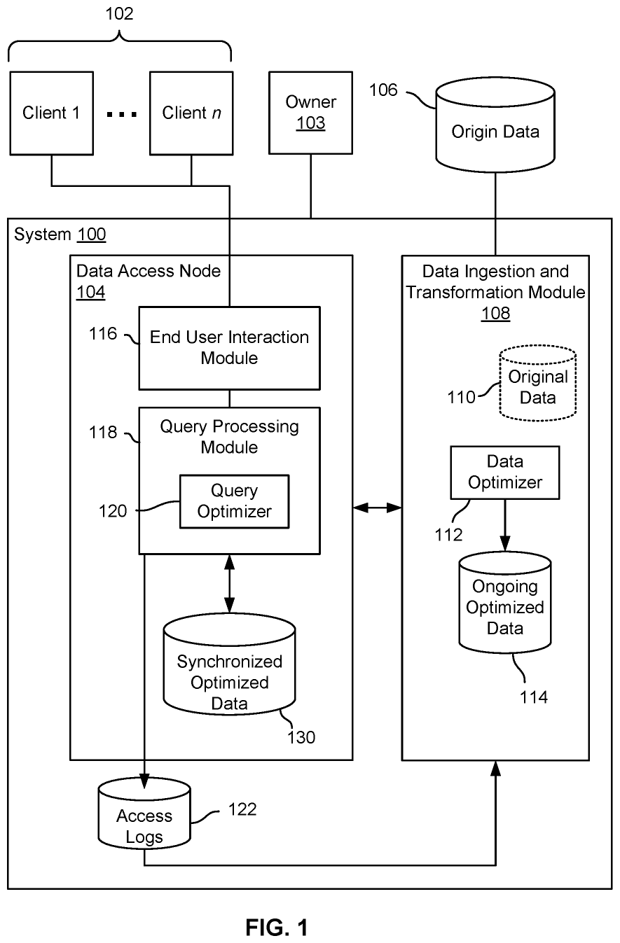

FIG. 1 is a block diagram illustrating an embodiment of a system for optimized data access. System 100 includes data access node 104 and data ingestion and transformation module 108. Clients 102, origin database 106, data access node 104, and data ingestion and transformation module 108 are like their counterparts in the preceding figures unless otherwise described herein.

Data access node 104 is configured to communicate with clients 102 and to optimize query processing. Data ingestion and transformation module 108 is configured to communicate with origin database 106 and optimize data. Data ingestion and transformation module 108 and data access node 104 are communicatively coupled, and cooperate to improve clients' user experience by improving response times to queries making data more readily accessible among other performance improvements.

For example, in some embodiments, data access node 104 polls data ingestion and transformation module 108 for new data, which is data different from the data received previously from data ingestion and transformation module 108. The new data is stored in ongoing optimized data store 114. Synchronized optimized data store stores the new data. This enables data access node 104 and data ingestion and transformation module 108 to share information while working independently to perform optimizations, the results of which may be combined in various embodiments.

Data access node 104 and data ingestion module 108 may cooperate as follows. Suppose some data from different tables in origin database 106 are combined into a single table in ongoing optimized data store 114 or vice versa (the single table is in synchronized optimized data 130). A specific index is selected to be used when searching based on information in synchronized optimized data store 130 and query trends identified by data access node 104. Data ingestion and transformation module 108 generates statistics about the data that are useful to data access node 104 or vice versa. Data ingestion and transformation module 108 helps to perform part of a useful query optimization such as an expensive SQL JOIN. Then the data access node 104 creates indexes on the resulting JOIN table.

Data ingestion and transformation module 108 includes data optimizer 112, ongoing optimized data store 114, and optionally a copy of original data 110. Data ingestion and transformation module 108 is configured to transform data received from origin database 106. In various embodiments, the data ingestion and transformation module performs the transformation according to a set of transformations determined by data optimizer 112.

Data optimizer 120 may include and/or be implemented by an optimization module, process/function completed by cooperation between data access node 104 and data ingestion and transformation module 108, and/or layer. In various embodiments, data optimizer 112 comprises a machine learning layer configured to determine an optimal set of data structures and indexes to store and provide access to data received from origin database 106.

Initially, in some embodiments, data may be stored only in its original form (e.g., in store 110). Over time, however, data optimizer 112 determines optimal data transformations, such as storing data from two or more relational tables in a single compound data structure, and/or indexing data differently than it may be indexed at origin database 106. Referring further to FIG. 1, transformed data from origin database 106 is stored in ongoing optimized data store 114. Data optimization may be an ongoing or repeated process that updates the optimized data stored in store 114.

Data access node 104 includes end user interaction module 116, query processing module 118, query optimizer 120, and synchronized optimized data store 130. Requests (e.g., database queries, application-level requests that require queries to be performed, etc.) from client systems 102 are received and processed by end user interaction module 116. In some embodiments, end user interaction module 116 may include application code, user interface code, etc. In some embodiments, end user interaction module 116 may be configured to receive and respond to SQL and/or other queries from clients 102 and/or implied by and/or otherwise required to be performed to respond to requests received from clients 102.

Queries required to respond to requests from client systems 102 are processed by query processing module 118, which includes a dynamic query optimizer 120. Query optimizer 120 may include and/or be implemented by an optimization module, process, and/or layer. In various embodiments, query optimizer 120 determines an optimized manner in which to perform a given query, e.g., applying conventional query optimization techniques in light of what is known about how the data has been stored and indexed in optimized data 114.

In the example shown, data optimizer 112 included in data ingestion and transformation module 108 performs optimization processing to determine the optimal data structure(s) and/or format in which to store and/or index data ingested by data ingestion and transformation module 108. In various embodiments, the optimization processing is performed offline in batch operations, e.g., using the original data 110. In other embodiments, a remote optimization service may perform optimization processing.

In various embodiments, access logs 122 generated by query processing module 118 and/or received from other, remote data access nodes, are used by optimizer 112 to determine and/or update optimizations to transform and/or index data received from origin database 106. Over time, data in origin database 106 may change, as may the subset of data ingested and stored in local data store 110, queries received from clients 102, priorities of the data owner, etc. Data received from origin database 106 is stored in its original, as-received format in original data store 110. In various embodiments, data optimizer 112 and/or another optimization module, system, or service uses original data 110 and data access patterns and/or statistics (e.g., from logs 122) to attempt to determine an updated optimal set and type of data structures and/or indexes to be used to store and provide access to data received from origin database 106. In some embodiments, the data optimizer 112 performs optimization processing (e.g., using machine learning, artificial intelligence, and/or other techniques), e.g., nightly, or continuously, until currently optimized to current conditions, etc., in an ongoing effort to improve data access.

While in various embodiments techniques disclosed herein may be implemented on and/or with respect to a system such as system 100 of FIG. 1, in various other embodiments techniques disclosed herein may be implemented on one or more systems different in one or more respects from system 100 of FIG. 1.

Techniques are disclosed to provide optimized access to data that resides in an origin database, such as a fully-functional enterprise class database system. In various embodiments, techniques disclosed herein are implemented as a device and/or one or more software applications running on a computer with a database that automatically optimizes data access for one or more of performance, resource optimization, cost management/optimization (e.g., for cloud-based computing and/or storage resources for which payment is a function of use/consumption, etc.), load management for different utilization curves, etc.

In various embodiments, a system as disclosed herein includes one or more components to perform or provide one or more of the following: a system/algorithm to identify when and what changes to make to data, dynamically optimized indexes, dynamically allocated memory, and a dynamically distributed data architecture which can be used alone or in combination to optimize the performance and/or cost profiles.

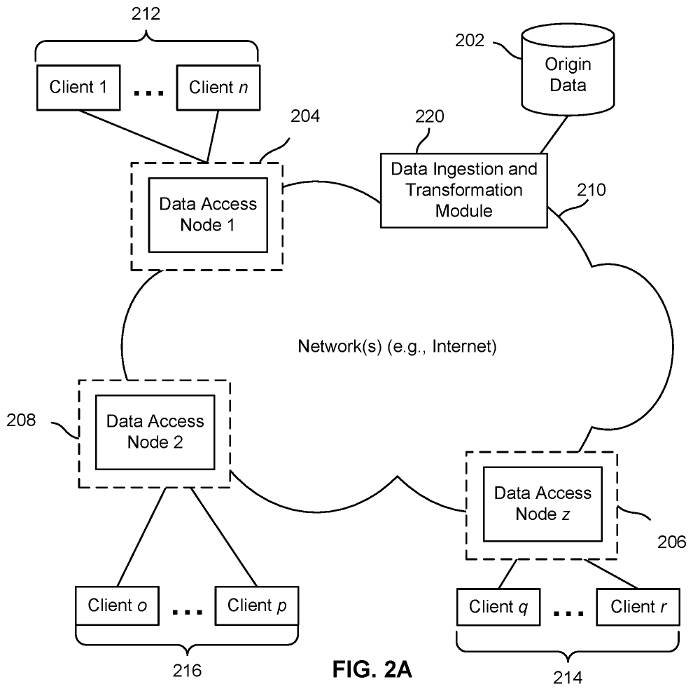

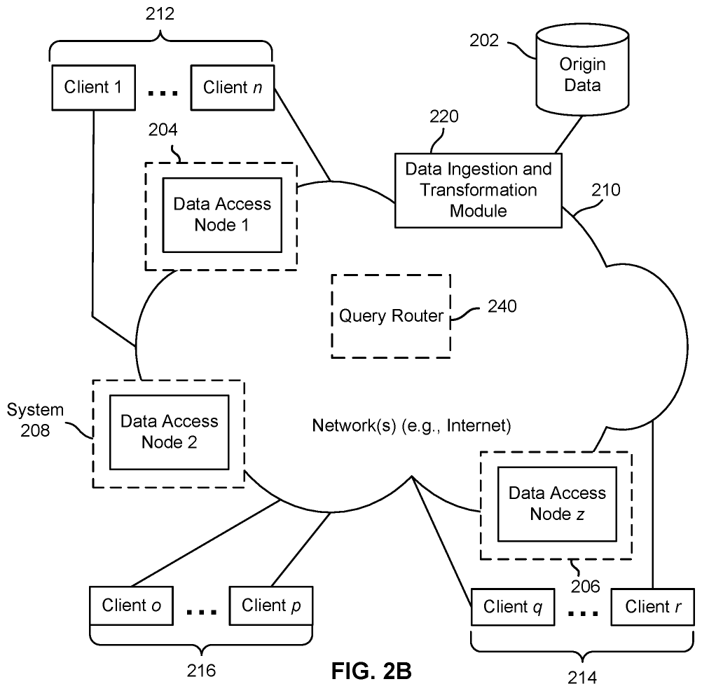

In some embodiments, the techniques disclosed herein are implemented on or with respect to a system such as system 100 of FIG. 1 and/or a system and environment comprising a distributed set of data access nodes, such as the system and environment shown in FIGS. 2A and 2B. In some embodiments, the techniques disclosed herein are implemented with respect to systems other than as shown in FIG. 1 and/or in system and environments other than as shown in FIGS. 2A and 2B. In various embodiments, one or more techniques and features described below may be implemented.

In various embodiments, techniques disclosed herein may be used in an environment and system comprising a distributed set of systems. For example, the system shown in the figures above can be included in (e.g., part of) a larger system that includes several sets of data access nodes and data ingestion and transformation modules as shown in the FIGS. 5 and 6.

FIG. 2A is a block diagram illustrating an embodiment of a distributed access an environment comprising two or more systems. In various embodiments, the systems 204, 206, and 208 each includes a data access node implemented as data access node 104 in the system 100 of FIG. 1. In this example, each system 204, 206, 208 includes a data access node associated with a common data ingestion and transformation module 220. In the example shown, clients 212, 214, and 216 are connected to systems 204, 206, and 208, e.g., directly and/or by one or more networks and/or Internet 210. Similarly origin database 202 may be connected to systems 204, 206, and 208 by one or more networks and/or Internet 210. One or more data access nodes or one or more data ingestion and transformation modules may be located on the edge, e.g., closer to the clients to decrease response times and reduce bandwidth needed to communicate with associated clients.

In the example shown, access to data included in origin database 202 is provided via distributed systems, represented by systems 204, 206, and 208. Systems 204, 206, and 208 may be distributed geographically, logically, or otherwise. Here, systems 204, 206, and 208 are distributed geographically and are shown to be configured to provide access to a local set of clients 212, 214, and 216, respectively.

In various embodiments, each set of clients 212, 214, and 216 may be configured to access data via one or more of associated data access nodes in systems 204, 206, and 208. The clients may access different origin databases. For example, the system accesses data from different databases, optimizes the combined data for access by the clients. The clients may be associated with different and potentially overlapping subsets of data. Application level requests from clients 212, 214, and 216 are routed, e.g., by IP address, application instance identifier, user agent identifier, or otherwise, to corresponding data access nodes 204, 206, and 208, respectively. For example, routing is influenced by location, client type, or the like.

In various embodiments, each system 204, 206, and 208 stores an associated subset of data from origin database 202. Each may store different data than one or more other of the systems 204, 206, and 208. Each may store data in the same or a different format and/or data structures as other of the systems 204, 206, and 208. For example, a first system may store a set of data in one set of one or more data structures, while a second system may store the same data in a different set of one or more data structures. In various embodiments, the system operates on a production database or copy of the production database, and selects another data structure to organize the subset of data based on a set of queries.

Data may be distributed in variety of ways including by separating data based on target audiences (such as shoes on one server and dresses on another server), geographical location, performance characteristics, or the like.

Examples of performance characteristics include as latency of queries or relative value of queries. For example, low-latency queries, demanding the earliest possible responses, are separated from queries without such needs. Low-latency queries benefit from having data organized in ways that match their desired result structure. Transforming origin data to match the query's needs improves throughput and reduces latency. Distributing such transformed data to nodes receiving the majority of the aforementioned queries further improves latency for individual queries, and improves throughput for the node as a whole. As an example, a query requesting the price for a stock selected through membership in any of several sector criteria might be considered a low-latency query, whereas a request for the total number of outstanding shares would not be considered as such.

As another example, queries considered to be more valuable such as those made at a critical juncture in a workflow, are separated from other queries by organizing the data to ensure that the query will complete with reduced latency and the least likelihood of failure. Suppose a valuable query requires accessing all the information concerning a user's e-commerce shopping cart, which the system disclosed herein optimizes by ensuring that all cart data is available to all nodes and is organized to minimize the time needed to implement a successful checkout process. If that query had less value, the data may be organized differently and involve more manipulation within the data nodes. Less valuable queries might take longer than usual or potentially receive errors and require resubmission with less detriment to the user experience. In some embodiments, several different copies of a data set, each organized to optimize different access policies, may be maintained.

Likewise, in various embodiments, each system may index (the same, partially the same, and/or different) data differently than one or more other systems. For example, indexes or index types are selected based on a predominant query for node such as a database instance.

Each system 204, 206, and 208 may be optimized differently than one or more other systems. For example, each system 204, 206, and 208 may be optimized independently of one or more other systems based on the subset of data stored at that system, the queries anticipated to be received at that system, local (e.g., regional, national) preferences and/or regulatory or other requirements of a locale with which a given data access node is associated, different optimization parameters, different weighting of optimization parameters, etc. Each data ingestion and transformation module of systems 204, 206, and 208 may perform transformations differently than one or more other data ingestion and transformation modules.

The systems may coordinate with each other to share optimizations. In various embodiments, the systems may coordinate with each other to self-organize to share work including by optimizing or transforming at a least a first portion at a first system and at least a second portion at a second system. As an example, consider a query A whose repeated execution becomes a sizeable part of data node N1's bandwidth. Node N1 optimizes the query as best it can, but determines that a restructuring of the data would make the query substantially faster. Node N1 creates a new representation of the data being queried that matches the queries' needs, comprising any subsets of the full combination of data, index, and formatted results.

The benefits of data reorganization can be shared with other nodes as follows. In various embodiments, node N1 shares the determination that this data reorganization would be beneficial with the data ingestion and transformation module 108. Module 108 then creates a data transformation usable by other data nodes without requiring the other nodes to perform all and/or part of the transformation work locally. When desired, either the data node or the transformation module 108 may decide to change the data organization to suit current needs, such as reducing resource utilization, addressing a different query's needs, etc. Communications between data nodes need not go through a transformation engine as various embodiments of the communication pathways are possible.

FIG. 2B is a block diagram illustrating an embodiment of a distributed database access system. In the example shown, the system 200 of FIG. 2A has been augmented to include a query router 240. In various embodiments, the query router 240 is located (schematically) in a data access layer comprising distributed data access nodes 204, 206, and 208. In various embodiments, queries received from clients, such as clients 212, 214, and/or 216, are parsed and routed by the data access layer (nodes 204, 206, 208 and query router 240, in this example) to a data access node determined to be an optimal node to process and respond to the query.

For example, in some embodiments, each data access node 204, 206, 208 is configured to determine for each query whether to process the query locally or instead forward the query to another data access node for processing. In some embodiments, client requests are received first at a central node, such as query router 240, and the central node determines for each query a data access node to which to route the query for processing.

In various embodiments, the data access node to which to route a given query for processing may be determined based on one or more of the following:
Latency, queue depth, throughput, estimated time to respond and/or other measures of backlog, current capacity, performance, and/or availability at the access node that received the request;
Attributes of the query, such as query structure, type, or identifier, including in some embodiments which data access node(s) has/have data that has been selected, transformed, indexed, and/or stored in a manner associated with optimal access in connection with the query;
Query cost (e.g., how long it is expected to take to process);
Query syntax (e.g., SQL features/syntax used);
Tables accessed by query;
Tables accessed in combination with SQL syntax (e.g., two versions of table, optimized in different ways, one of which may be more optimal for given SQL syntax/features;
Latency and/or other costs associated with intermediate transmission and/or other actions and/or events associated with sending the query for processing to a given data access node;
Sensitivity, security, priority, data privacy, regulatory and/or other considerations associated with one or both of the query, the source of the query, and/or the data associated with the query;
Quality of service (QoS) or other service/performance guarantees associated with the requesting user and/or app and/or infrastructure and/or QoS parameter associated with the query; and/or
Other considerations.

In some embodiments, a query is parsed and processed to determine an optimal data access node to service the query. For example, a query may be recognized based on a query identifier associated with the query as being optimally serviced by one or more data access nodes and/or by one or more versions or instances of optimized data as stored at various access nodes. In some embodiments, the query may be recognized and/or identified at least in part as described in Appendix A in connection with continuous optimization of query planning.

In various embodiments, a request may be routed to a data access node selected as being optimal to process and respond to the query based on processing implemented at any one or more layers in an n-layer architecture, including without limitation one or more of the following:
At a client system at which the query originated, e.g., by operation of SDK or other client side code;
At an application server or other server associated with origination of the request;
At a query router interposed between one or more of a client system, application server, traditional database access server, on the one hand, and the selected distributed data access node on the other; and
At a data access node that received the request, e.g., from a client system.

In some embodiments, query routing to an data access node/instance optimal to process that query is performed at least in part at a client system, e.g., by operation of SDK or other client side code. For example, the client may be configured to route each query to the right database instance (e.g., instance currently most optimal to service the query, instance associated with a quality of service or other performance guarantee applicable to the query, etc.). In some embodiments, the clients does this by tracking one or more parameters related to the query, identifying the policy to be used to determine how to route the query, and then applying one or more filters against the metadata of that specific query that has been generated in the database system.

In some embodiments, to avoid having to parse the query at the client in order to route the query to an optimal data instance, which would require more complicated and more difficult to maintain code to be maintained at each client, a client-side data access SDK in various embodiments uses techniques based on the SQL “PREPARE” command to cache optimizations associated with a query associated with a session. In some embodiments, the data flow of the “PREPARE” command is altered to capture metadata from a distributed and optimized data access system as disclosed herein, which enables the metadata to be used at the client to route/direct a given query to a data instance/node optimal to service the query. An example of pseudocode to implement such an approach follows:

session=openDB(credentials)
query=session.BuildQuery(Š)
preparedQuery=session.PrepareQuery(query)
results=preparedQuery.Execute(param1, param2, Š)

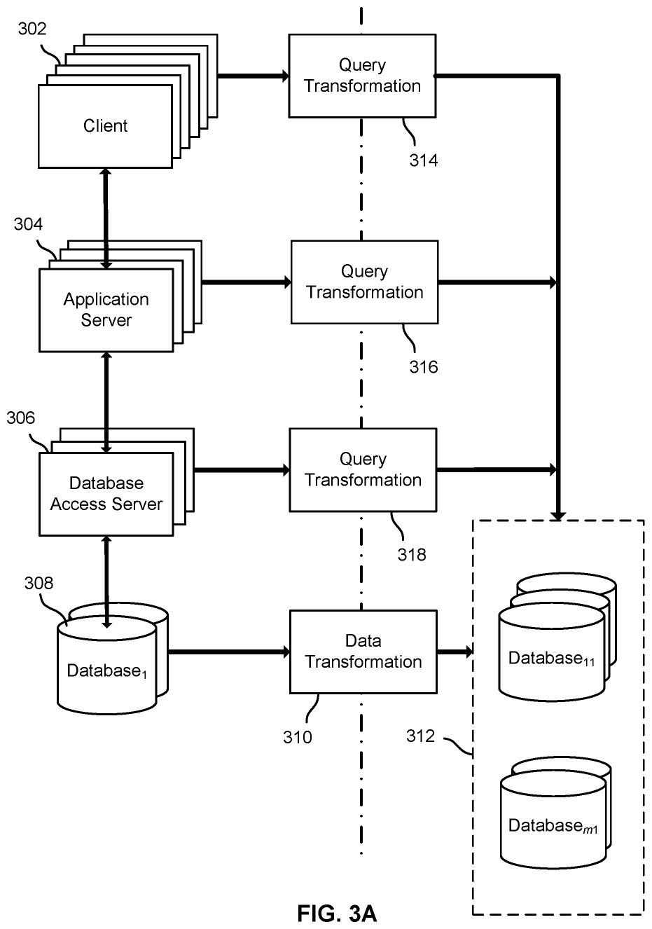

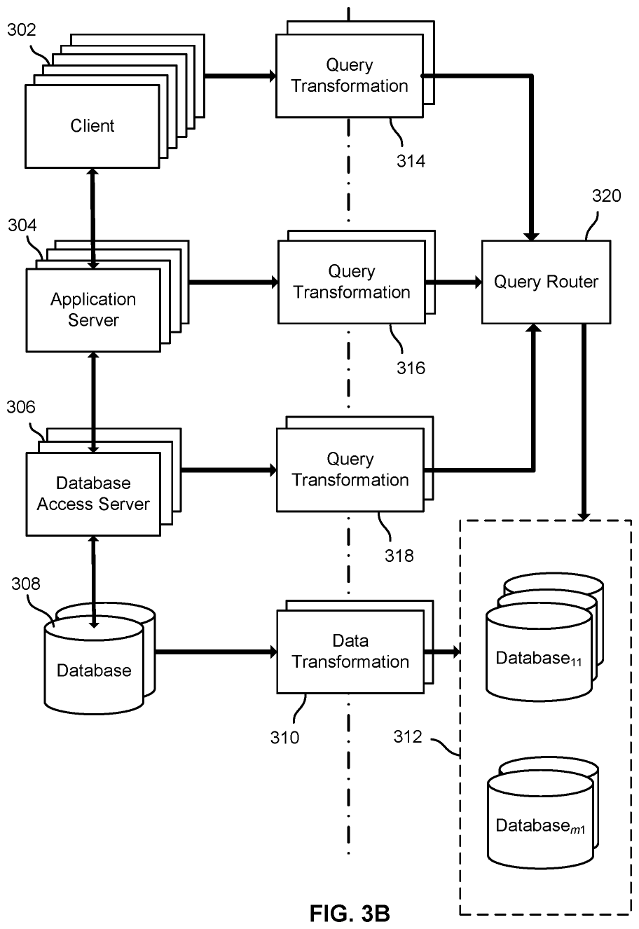

FIG. 3A is a block diagram illustrating an embodiment of a distributed database system configured to provide optimized data access, including by processing a query at a data access node selected as being optimal to process that query. In the example shown, a plurality of clients 302 are configured to send application level requests to application servers 304, which in turn send database queries to database access servers 306 to access data stored in databases 308. The clients 302 may comprise client side application level code, browser software, or other client side code to access the application servers 304. The application servers 304 may represent and provide access to a plurality of different applications and/or each application may be running and/or otherwise available on a plurality of application servers 304 and/or in a plurality of virtual machines, containers, or the like on a single application server 304. Likewise, applications servers 304 may access a plurality of different database access servers 306 and/or may access data in more than one database 308.

In the example shown, databases 308 include a plurality of databases 1 through m. For each database 308, one or more transformed instances each comprising at least a subset of data from the source database 308 have been created and are maintained in sync with the source database 308 at least in part by transforming the subset of data via a data transformation process/module 310. The resulting transformed data instances 312 include for each of the databases 308 one or more optimized data sets (e.g., database11 is a first instance of an optimized subset of database1). In various embodiments, two or more differently optimized data instances may be created and included in transformed data instances 312 for a given database 308. Each differently optimized data instance 312 may be optimized for a corresponding set of one or more queries, as described above. Each instance 312 may be stored on a same or on a remote/different data access node as one or more other instances associated with the same source database 308.

In the example shown in FIG. 3A, a query may be routed to an optimized data instance 312 for processing at any tier, i.e., by a client 302, an application server 304, or the traditional database access server 306. For example, a software entity at one of the tiers may recognize that an optimized data instance 312 may be optimal to service a query.

While three tiers are shown in FIG. 3A (i.e., client/presentation tier at clients 302, application/logic tier at applications servers 304, and data/database tier accessed via database access servers 306), in various embodiments more or fewer tiers may be present. In various embodiments, each tier and/or only a given one or more of them may be configured to direct/redirect queries to an optimized data instance (e.g., 312) determined to be optimal to service that query at that time.

In the example shown in FIG. 3A, a query directed to be serviced by a data access node associated with an optimized data instance 312 is transformed by a corresponding query transformation process, module, and/or node 314, 316, 318. In various embodiments, query transformation 314, 316, 318 transforms the query into a form that is optimized to take advantage of the data transformation and optimization performed to create/maintain the optimized data instance 312. For example, metadata created and/or used by data transformation process/module 310 may be used by query transformation modules/processes 314, 316, 318 to transform queries in a manner informed by the data transformations performed by data transformation process/module 310.

While query transformation 314, 316, 318 is performed in the example shown in FIG. 3A, in some alternative embodiments queries are not transformed prior to being serviced by/using optimized data instances 312. In some such embodiments, data optimizations performed to create and maintain optimized data instances 312 result in faster processing of the untransformed query, e.g., by including only a needed subset of data, indexing data differently to be able to more quickly process the query, nesting some additional data within an original table to provide quicker access, etc.

In some embodiments, a query may be directed to a specific optimized data instance 312, e.g., an instance optimized for and/or optimal to service the query, and the query transformation 314, 316, 318 may be specifically optimized to take advantage of the transformations/optimizations performed to create that specific optimized data instance 312.

FIG. 3B is a block diagram illustrating an embodiment of a distributed database system configured to provide optimized data access, including a query router configured to select a data access node as being optimal to process a given query. In the example shown, decisions as to which specific optimized data instance 312 will be accessed to service a given query are (or may be) made (or reconsidered) by a query router 320. In various embodiments, query router 320 parses a query, determines attributes to be used to route the query to an access node associated with a specific optimized data instance 312, determines the specific optimized data instance 312 to service the query, and sends the parsed query to the selected specific optimized data instance 312.

In various embodiments, query router 320 may be configured to make routing decisions based on any rule or criteria, including without limitation rules and criteria described herein, such as attributes of the query and corresponding attributes of the respective differently optimized instances 312 of the underlying data and/or load balancing type considerations, such as observed latency, query queue depth, etc.

In various embodiments, techniques disclosed herein are used in the context of a system configured to perform continuous query optimization. In various embodiments, a “query” exists and persists as a first class object. The query object or other representation and associated optimized plan(s) may be stored persistently. Offline, for example subsequent to responding to an instance of the query, e.g., by returning a query result, the query object or other representation may be used to perform further optimization processing to determine a further optimized plan to be available to be used to process a future instance of the query.

Database query processors include planners, which convert the declarative SQL language into imperatives that can be executed on hardware. These planners work on each query as it is received by a database. The time taken to parse the query and make an execution plan can be a major portion of the query processing time. To reduce query processing times, planners typically are given a time budget, also known as a time-box. Should the planning effort not complete within this budget, the planner responds with the best plan it discovered within the time-box.

A singular query may be executed repeatedly in any of several contexts, including but not limited to the same transaction, the same session, and the same database, with any of the aforementioned being executed by the same user, different users in the same organizational context, or different organizations. A query may be parameterized, meaning that some syntactic and/or semantic porting of the query may be subject to assignment or substitution when the query is executed as opposed to when the query is compiled. Query plans may change depending upon the arguments presented to the query, which is expensive compared to using an existing plan.

In various embodiments, continuous query optimization is performed as follows:
1. The requestor presents the query to the database system/service (DB) paradigm and API handler.
2. The query is presented to the parser.
3. The parser produces an Abstract Syntax Tree.
4. The AST is returned to the API Handler.
5. The AST is presented to the planner.
6. The planner generates a query for execution by the database executor, labeled “ILDBExecutor” in this example.
7. The planner returns the query, labeled “ILDBExecutor query” in the diagram, to the API Handler.
8. The API Handler presents the ILDBExecutor query to the ILDBExecutor
9. The planner, still active, continues processing to (further) optimize the query.
10. The ILDBExecutor executes the ILDBExecutor query.
11. The ILDBExecutor returns the query+results to the API Handler
12. The results are returned to the requestor.
13. The planner further optimizes the query and one or more other queries, continuously (in this example) working to produce the most highly optimized plan possible, for each of a plurality of queries.
14. The requestor (or another requestor, in some embodiments) presents another query to the Paradigm/APIHandler component of the system.
15. The parser produces an Abstract Syntax Tree.
16. The AST is returned to the API Handler.
17. The AST is presented to the planner.
18. The planner finds an optimized query and associated plan in the cache. In some embodiments, all or part of the AST is processed to identify the query that is currently being processed as being associated with a previously-received query for which an optimized plan is in the planner's cache of optimized plans.
19. The planner returns the highly optimized query plan, e.g., in the form of a highly optimized query executable by the query executor (ILDBExecutor in this example).
20. The API Handler presents the plan to the executor.
21. The executor executes the plan, while the planner concurrently further optimizes queries.
22. The query results are presented to the Paradigm API Handler.
23. The results are returned to the Requestor.
24. The planner continues to optimize queries, and so on.

Performing continuous optimization as disclosed herein is different from traditional “query caching”. In the latter approach, a query and the returned results are cached. If the identical query is received while the results remain in the cache, the cached results are returned. By contrast, in the approach disclosed herein, the query and an associated optimized plan are cached. The optimized plan is updated as the continuous optimization processing determines a more highly optimized plan for the query. A subsequent query that is associated with the query for which a highly optimized plan exists in the query-optimized plan cache (or other data store) is responded to, as disclosed herein, not (necessarily) by returning previously-cached results but instead by using the cached optimized plan to generate results for the query. This approach in various embodiments enables a subsequent query that is (essentially) the same as a previous query for which a highly-optimized plan is cached to be executed using the cached plan, even if one or more arguments of the later-received query are different than the previously-processed query. Also, results can be returned quickly using the cached plan even if the data has changed, since the cached plan is executed at run time to generate results to respond to the later-received query.

In various embodiments, queries are treated as first-class object. Treating queries as first-class objects gives them an identity independent of their value. In various embodiments, this approach allows potentially different expressions of the query to retain an identity beyond a single query execution. In various embodiments, objective identity for queries dramatically improves the speed with which queries used in different contexts can be assumed to be the same query, as the character representation of the query need not be used, only the identity. In various embodiments, objective identity provides a natural, unique reference to which plans and other related information can be associated. In various embodiments, query identity is used to route or otherwise optimize data access in response to a query.

In some embodiments, to determine equivalence, a query may be parsed and/or otherwise transformed into a canonical form, such as an AST or other hierarchical representation. A string representative of a semantically relevant portion of the representation may be derived and stored (or a hash or other signature thereof may be stored and/or otherwise associated with the query and/or the (continuously) optimized plan for the query. A subsequently received query may be processed at least in part by similarly parsing/transforming the query to derive the corresponding string or other part, and the derived information used to determine if an optimized plan for the query is stored. If so, the optimized plan is used to perform the query. In various embodiments, one or more arguments (parameters) comprising the query may be used to populate the optimized plan for execution to respond to the query. In various embodiments, parsing and determining equivalency between a received query and previously-process query may be used to determine an optimal response to a query, e.g., by determine where to route the query for processing.

In various embodiments, techniques disclosed herein enable each query to be routed to and serviced by an optimized data instance that is optimal to process that query at that time.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
a communication interface; and
a processor coupled to the communication interface and configured to:
receive a database request via the communication interface;
parse the request to extract one or more data elements associated with the request;
select, based at least in part on the one or more data elements extracted from the request, a selected one of a plurality of partial data set instances, each partial data set instance including a corresponding subset of data from a set of origin data; and
route the request to the selected partial data set instance.

2. The system of claim 1, wherein the processor is included in a client system associated with the database request.

3. The system of claim 1, wherein the processor is included in an application server associated with the request.

4. The system of claim 1, wherein the processor is included in a database access server associated with the request.

5. The system of claim 1, wherein the processor is included in a query router.

6. The system of claim 5, wherein the database request is received from one or more of a client system, an application server, and a database access server.

7. The system of claim 1, wherein the processor is further configured to transform a query associated with the database request and to select the selected one of the plurality of partial data set instances based at least in part on the transformed query.

8. The system of claim 7, wherein the query is transformed into a query form associated with optimal access to data associated with the database request from the selected one of the plurality of partial data set instances.

9. The system of claim 1, wherein the processor is configured to select the selected one of the plurality of partial data set instances based at least in part on metadata associated with the request.

10. The system of claim 9, wherein the selection is based at least in part on a requesting user with which the request is associated.

11. The system of claim 1, wherein the processor is configured to select the selected one of the plurality of partial data set instances based at least in part on requested data associated with the request.

12. The system of claim 11, wherein the selected one of the plurality of partial data set instances is configured to store the requested data associated with the request in a form associated with optimized access to the requested data in response to the request.

13. The system of claim 1, wherein the processor is configured to determined based on data extracted from the request a persistently-stored query identifier associated with the request.

14. The system of claim 13, wherein the processor is configured to select the selected one of the plurality of partial data set instances based at least in part on the query identifier.

15. The system of claim 1, wherein the processor is configured to select the selected one of the plurality of partial data set instances based at least in part on one or more of the following: load balancing among the plurality of partial data set instances; one or more quality of service guarantees associated with the request; a policy; a priority; dynamically determined state information; and one or more rules, policies, or heuristics.

16. The system of claim 1, wherein the processor is configured to select the selected one of the plurality of partial data set instances based on dynamically-determined state information, including one or more of dynamically-changing subsets of data included in the respective partial data set instances; dynamically-updated indexes associated with one or more of the partial data set instances; dynamically-determined workload or other state information associated with the respective partial data set instances; and detected changes in patterns of data access from one or more of the partial data set instances.

17. A method, comprising:
receiving a database request via a communication interface;
parsing the request to extract one or more data elements associated with the request;
selecting, based at least in part on the one or more data elements extracted from the request, a selected one of a plurality of partial data set instances, each partial data set instance including a corresponding subset of data from a set of origin data; and
routing the request to the selected partial data set instance.

18. The method of claim 17, wherein the processor is further configured to transform a query associated with the database request and to select the selected one of the plurality of partial data set instances based at least in part on the transformed query.

19. The method of claim 18, wherein the query is transformed into a query form associated with optimal access to data associated with the database request from the selected one of the plurality of partial data set instances.

20. A computer product embodied in a non-transitory computer readable medium, comprising computer instructions for:
receiving a database request via a communication interface;
parsing the request to extract one or more data elements associated with the request;
selecting, based at least in part on the one or more data elements extracted from the request, a selected one of a plurality of partial data set instances, each partial data set instance including a corresponding subset of data from a set of origin data; and
routing the request to the selected partial data set instance.
